(19) United States
(12) Patent Application Publication
(10) Pub. No.: US 2019/0104467 A1
(43) Pub. Date: Apr. 4, 2019

(54) Slotted channel access in communications network

(71) Applicant: Robotonchip Oy, Espoo (FI)

(72) Inventors: Jari Rahkala, Espoo (FI); Marko Lamminaho, Espoo (FI)

(21) Appl. No.: 16/114,270

(22) Filed: Aug. 28, 2018

(30) Foreign Application Priority Data
Sep. 29, 2017 (FI) 20175866

(51) Int. Cl. H04W 52/02; H04W 74/08; H04W 56/00; H04W 72/04

(52) U.S. Cl. CPC H04W 52/0203; H04W 72/0446; H04W 56/001; H04W 74/0816

(57) ABSTRACT

According to an aspect of the present invention, there is provided determining a current proportional number of access slots for communications in the communications network, generating predictions of a next active access slot on a communications channel on the basis of the current proportional number of access slots, switching ON, from a low power mode, a communications unit on the basis of at least one generated prediction for the next active access slot for an operation comprising at least one of a transmission of data, reception of data and synchronization, switching the communications unit back to the same low power mode or to another low power mode after the operation has been performed, and adapting at least one of the generated predictions for the next active access slot on the basis of feedback for operations performed in one or more previous active access slots.

### FIELD

The present invention relates to slotted channel access in a communications network.

### BACKGROUND

Access protocols are used to control access communications channels in communications networks. Access to a communications channel in a communications network can be controlled in a centralized manner by a single node or the control may be distributed between nodes. When the access control is distributed to the nodes, the nodes determine collectively, for example by channel sensing and optionally applying collision avoidance, which node obtains access to the communications channel. Examples of conventional access control protocols comprise Aloha, slotted Aloha, Collision Sense Multiple Access (CSMA) and CSMA with Collision Avoidance (CA).

With increasing number of nodes that access the communications channel the time, e.g. a competition time, to determine the node that obtains access to the communications channel is also increased. When the number of nodes is high, the likelihood of interfering transmissions on the communications channel is higher than when the number of nodes is low. Therefore, the actual served traffic by the communications channel can be negatively affected by the high number of nodes. Furthermore, when the time to determine which node has access to the communications channel is increased, also the power consumption of the nodes is increased.

The number of devices connected to networks is increased by the use of Internet of Things IoT devices. Without external power supplies, the IoT devices and their sheer number brings about challenges to access control in networks and power consumption.

### SUMMARY OF THE INVENTION

The invention is defined by the features of the independent claims. Some specific embodiments are defined in the dependent claims.

According to a first aspect of the present invention, there is provided a method for slotted channel access in a communications network, comprising:

determining, by a node of the communications network, a current proportional number of access slots for communications in the communications network;
generating, by the node, predictions of a next active access slot on a communications channel on the basis of the current proportional number of access slots;
switching ON, from a low power mode, a communications unit of the node on the basis of at least one generated prediction for the next active access slot for an operation comprising at least one of a transmission of data, reception of data and synchronization;
switching the communications unit of the node back to the same to low power mode or to another low power mode after the operation has been performed;
adapting at least one of the generated predictions for the next active access slot on the basis of feedback for operations performed in one or more previous active access slots.

According to a second aspect of the present invention, an apparatus comprising at least one processing core, at least one memory including computer program code, the at least one memory and the computer program code being configured to, with the at least one processing core, cause the apparatus at least to perform a method according to the first aspect.

According to a third aspect of the present invention, there is provided a computer program configured to cause a method in accordance with at least one aspect to be performed.

According to a fourth aspect of the present invention, there is provided a non-transitory computer readable medium having stored thereon a set of computer readable instructions that, when executed by at least one processor, cause a network node to at least perform a method according to the first aspect.

### BRIEF DESCRIPTION OF THE DRAWINGS

FIG. 1 illustrate a method in accordance with at least some embodiments of the present invention;

FIG. 2 illustrates a communications network in accordance with at least some embodiments of the present invention;

FIG. 3 illustrates an example of utilizing predictions for determining active access slots in accordance with at least some embodiments of the present invention;

FIG. 4 illustrates an example of a communications network in accordance with at least some embodiments of the present invention; and

FIG. 5 illustrates an apparatus in accordance with at least some embodiments of the present invention.

### EMBODIMENTS

Slotted channel access is now provided for network nodes. The slotted channel access facilitates scalability of channel access opportunities, whereby also power consumption of the network nodes may be kept low. Predictions of a next active access slot on a communications channel are generated on the basis of a current proportional number of access slots. A communications unit is switched ON based on a prediction for the next active access slot. The communications unit is switched to a low power mode after the access slot has been used for at least one operation of transmission of data, reception of data and synchronization. At least one of the generated predictions is adapted for the next active access slot on the basis of feedback for operations performed in one or more previous active access slots.

In this context a node may refer to a device or apparatus connected to one or more other nodes in a communications network. It should be appreciated that in the absence of other devices in the network, the node may be connectable to other devices, when other devices become present. The node may be a user device, an IoT device and a terminal device.

Connections between the nodes may be established over wired or wireless communications channels. Examples of the wireless communications channels comprise wireless local area networks according to IEEE 802.11 family of standards and Bluetooth. Examples of the wired communications channels comprise data buses and Ethernet, for example.

Communications on the communications channels may be arranged in access slots. The access slots may be time slots defined by time periods on the communications channel. A node may utilize an access slot for transmitting or receiving data on the communications channel or for synchronizing to the communications channel. The access slot may be defined at least by a time instant of the beginning of the access slot. Also other time instants are viable for defining the access slot. The access slot may have a duration that is scalable. Communications on the communications channels may comprise simplex, half duplex, or full duplex communications. The communications channels may support point-to-point, point-to-multipoint, multipoint-to-multipoint, multipoint-to-point connections between the nodes.

Preferably, the communications on a communications channel is synchronized. The synchronized communications provides that timing of the nodes utilizing the communications channel may be accurate.

An access slot may be referred to an active access slot, when the access slots is utilized by a node for transmitting or listening the communications channel. Utilizing the an access slot for receiving data or synchronizing may be both regarded as listening the communications channel. An active access slot or more than one consecutive active access slots may be followed by a low power mode before any further active access slots. During the low power mode, all nodes that have the same synchronization may be in the low power mode, for example sleeping.

Predictions provide that during a given active access slot only a single node would be transmitting in its neighborhood, while other nodes within the neighborhood are listening to the communications channel. However, without predictions in principle all nodes would follow the same plan for active access slots, whereby transmissions of the nodes would collide.

A communications network may be a mesh network. Also other types of communications networks are viable. In the mesh network, nodes cooperate in distribution of data in the network. The data may be distributed by flooding and/or by routing over connections, i.e. hops, between the nodes. The mesh network may be a wireless network or a wired network. In a wireless mesh networks, communications is performed over a wireless communications channel. In a wired mesh network communications is performed over a wired communications channel.

A time period between subsequent switching of the communications unit ON may be referred to a duty cycle. A resting period of the duty cycle begins after the communications unit is switched to a low power mode after being switched ON. The resting period ends, when the communications unit is switched ON after entering a low power mode. It should be appreciated that the communications unit may first enter or be in one low power mode, and thereafter be switched ON or be switched to one or more further low power modes before being switched ON. Duration of the resting period is a key element in achieving power savings in the slotted channel access according to various embodiments.

A communications unit may have more than one operational modes. The operational modes may be characterized by power consumption of the modes. Accordingly, the communications unit may have one operational mode, when the communications unit is ON. In this operational mode the communications unit may have a regular or even an increased power consumption compared to the regular power consumption. In the operational mode, when the communications unit is switched ON and has an increased power consumption, transmission power of the radio frequency transmissions of the communications unit may be increased above a transmission power by the communications unit used when the power consumption is regular. The increased transmission power may be increased above an allowable spectrum mask in the radio frequency channel for example. When the communications unit is in a low power mode, the communications unit may have a lower power consumption than when the communications unit is switched ON. In the low power mode the communications unit may be saving power compared to when the communications unit is switched ON. Accordingly, the low power mode may be referred to a power save mode. The low power modes of the communications unit may comprise at least a low power mode, where the communications unit is OFF. Additionally, the low power modes may comprise one or more further low power modes that may have higher power consumptions than when the communications unit is switched OFF. Examples of the low power modes having a higher power consumption may be a standby mode. In the standby mode transition of the communications unit to the operational mode when the communication unit is switched ON may be faster than transition from the operational mode when the communications unit is switched OFF to the operational mode when the communication unit is switched ON.

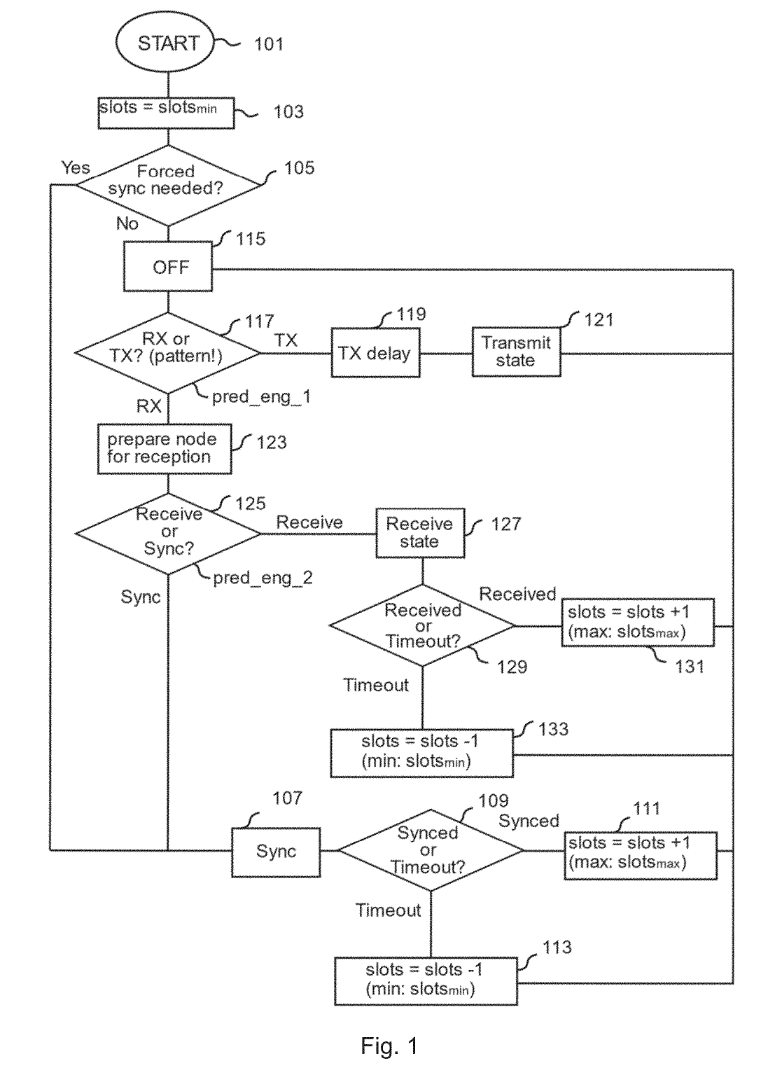

FIG. 1 illustrates a method for slotted channel access in a communications network in accordance with at least some embodiments of the present invention. The method provides channel access without channel sensing. In this way the energy efficient operation of the network nodes accessing a communications channel may be facilitated. The method may be carried out by a node capable of communications on a communications channel between nodes in the communications network. The node may be a node of a mesh network, where the communications channel is utilized for communications between the nodes.

In an embodiment, the channel access is a distributed channel access, where nodes may determine independently to utilize active access slots. Accordingly, each node may independently determine whether an access slot shall be utilized or shall not be utilized by the node. An access slot may be utilized by the node for transmitting data, receiving data or synchronization to the communications channel. An access slot utilized by the node may be referred to an active access slot. Each node of the independently operating nodes may execute a channel access protocol for determining a next active access slot for the node.

The process may start 101 upon switching ON the node such that the node may be capable of accessing the communications channel. The node may be switched on from a low power mode. The node may be capable of accessing the communications channel at least when a communications unit of the node is switched ON. When the communications unit of the node is switched ON, the node may be at least capable of transmitting and receiving data and/or signaling on the communications channel in at least one access slot of the communications channel. The access slot may be a resource unit on the communications channel for communications of data in the network. The access slots may be defined by a start time and duration of the access slot. The duration may be scalable.

A current proportional number of access slots, slots, may be determined 103. A proportional number of access slots may be determined on the basis of a relation between a total number of active access slots to active access slots utilized for transmitting. The current proportional number of slots of the node may be a predefined value of access slots that may be loaded from a memory of the node, for example during a startup sequence of operations executed, when the communications unit is switched ON. On the other hand the current proportional number of access slots may be determined over a sequence of past active slots, for example over one or more system frames. In an example the proportional number of access slots may be set to a minimum value slotsₘᵢₙ, slots=slotsₘᵢₙ, after the communications unit is switched ON. In an example, the minimum proportional number of access slots is 1. In this way the node may operate such that transmission of data, reception of data and synchronization is performed in the slots defined by the minimum proportional number of access slots and the node may apply a low power mode between active access slots.

In an example the total number of active access slots may be 3 and the number of active access slots for transmitting may be 1, whereby the proportional number of access slots is slots=3/1=3. In another example the total number of active access slots may be 4 and the number of active access slots for transmitting may be 1, whereby the proportional number of access slots is slots=4/1=4. It should be appreciated that active access slots that are not utilized for transmitting may be utilized for receiving or synchronizing. The number of proportional access slots may be calculated over a sequence of active access slots, for example over a system frame. It should be appreciated that within the sequence, the active access slots for transmitting may be distributed in various ways, for example evenly or unevenly, without affecting the number of proportional access slots for the sequence.

In step 105 a need for synchronization for the node is determined. An unsynchronized node may be forced to perform an initial synchronization to the communications channel. The node may have an initial synchronization, if the node serves as a beacon node in the communications network. The beacon node may be synchronized to an external synchronization source and serve as a synchronization source for other nodes of the network. However, if the beacon node stops operating as beacon node, the node may need to be synchronized to the communications channel. Examples of external synchronization sources comprise Global Positioning System (GPS) and atomic clock.

If the node has not performed an initial synchronization the method may proceed to synchronizing 107 the node to the communications channel. The synchronizing may comprise determining frame timing for the communications channel. The frame timing may be used for determining a system frame comprising access slots for communications on the communications channel. Each node may maintain its own system frame such that start times of the access slots are synchronized with the start times of the access slots of the system frames of the other nodes in the communications network. Additionally or alternatively, in a similar manner to synchronizing the start times, the end times of the access slots may be synchronized. The system frames of the nodes may be of the same length but may be shifted in time. On the other hand the system frames may be of different length.

If 109 the synchronization is successful, the proportional number of access slots may be updated 111 correspondingly, for example the proportional number of access slots may be increased by 1 or more access slots. If 109 the synchronization is not successful, the proportional number of access slots may be updated 113 correspondingly, for example the proportional number of access slots may be decreased by 1 or more access slots. An unsuccessful synchronization may be determined after a timeout takes place after initiating the synchronization, for example. After the updating 111, 113 of the proportional number of access slots, the node may switch to a low power mode 115 the communications unit. When the communications unit is in the low power mode, the channel cannot be accessed by the node and power may be saved. If it is determined 105 that there is no synchronization need for the node, the method may proceed to switching to a low power mode 115 the communications unit without synchronizing the node. There may be no synchronization need, if there is the node is synchronized and the time since last synchronization is below a threshold value, for example.

After the communications unit is switched to a low power mode 115, the communications unit may be switched ON based on one or more predictions generated for the next active access slot. The next active access slot may be for an operation of the node comprising at least one of a transmission of data in the active access slot, reception of data in the active access slot and synchronization to the communications channel. The predictions may be generated after the synchronization 107 is successful or after it has been determined 105 that there is no need for synchronization for example since the node is already synchronized. It should be appreciated that in a given active slot a transmission, reception or synchronization may be successful or unsuccessful. Therefore, a series of access slots may include operations that are either successful or unsuccessful or a mixture of successful or unsuccessful operations.

It should be appreciated that, generating a prediction may comprise that even if the generated predictions indicate that an access slot could be utilized by the node, e.g. that the access slot is free to use, the node may be maintained in the low power mode for power saving purposes. This may be particularly useful, for example when despite of previous synchronization attempts, other nodes are not found and synchronization has been unsuccessful, whereby it may be determined that the node is maintained in the low power mode. Accordingly, rate of the synchronization attempts may be decreased if previous synchronization attempts have not been successful.

Alternatively or additionally, generating a prediction may comprise that the node applies information of previous traffic patterns during a time period for predicting, whether the communications should be switched ON. In one example information of previous traffic patterns during time periods of one day may be utilized to predict a next active access slot. For example, if the information of previous traffic patterns indicates that it is unlikely that any data is to be received by the node e.g. during 6 p.m. and 7 a.m. the communications unit may be maintained in the low power mode. On the other hand if the node has data to be transmitted, the next active access slot may be predicted to take place during the time period, when there is known to be low data traffic based on the previous traffic pattern, e.g. between 6 p.m. and 7 a.m. On the other hand, in order to minimize retransmission due to the recipient being in a low power mode during the transmission of data, prediction of the next active access slot during a time period of the lowest traffic may be avoided. In one example the time period of the lowest traffic may be between 3 a.m. to 6 a.m.

The active access slot may be predicted on the communications channel with respect to a system frame. The system frame may define a time window during which access slots take place. The system frame may be determined on the basis of beacon transmission time and time instants of access slots may be determined with respect to the system frame. Positions of the access slots in the system frame may be determined for example from the beginning of the system frame.

If 117 the generated predictions indicate that the next active access slot is for transmission of data on the communications channel, the node applies a transmission procedure 119, 121 and after the transmission procedure, the communications unit is switched to a low power mode 115. The transmission procedure may comprise applying a transmission delay 119 and transmitting 121 data on the communications channel after the transmission delay. Applying the transmission delay allows that clock drifting between different nodes may be tolerated for optimizing a reception window.

If 117 the generated predictions indicate that the next active access slot is not for transmission of data, the next active access slot may be determined for a reception operation and the node is prepared 123 for the reception operation. Preparing the node for the reception may comprise setting of the node for a receiving state. Setting of the node to the receiving state may need some stabilizing time before the receiving state is operative. Alternatively or additionally the preparing may comprise taking into account node and RF-component specific timing differences between start of transmission operation and start of reception operation. Moreover, a reception window may be optimized such that possible clock drifting between different nodes may be tolerated.

If 125 the generated predictions indicate that the next active access slot is for reception of data, reception of the data may be initiated 127. If 129 the data is received the proportional number of access slots may be updated 131. The proportional number of access slots may be updated correspondingly, for example by increasing the proportional number of access slots by 1, slots=slots+1. The proportional number of access slots may have a maximum number, slotsₘₐₓ, which is not exceeded, when the proportional number of access slots is updated 131. If 129 the data is not received, the proportional number of access slots may be updated 133 correspondingly, for example by decreasing the proportional number of access slots by 1, slots=slots−1. It may be determined that data is not received if a timeout takes place after initiating the reception of data, for example. The proportional number of access slots may have a minimum number, slotsₘᵢₙ, under which the proportional number of access slots is not updated 133. After the proportional number of access slots is updated 131, 133, the communications unit is switched to a low power mode 115. Increasing or decreasing of proportional number of access slots may differ from amount of 1 e.g. it may be weighted by proportional number of access slots count number like slots=10+0.9*1, where effectively is used 10 instead of 10.9, when weighted addition is 0.9 instead of 1. Also proportional number of access slots may step discontinuously effectively used values like 1, 3, 7, 15, 31.

In at least some embodiments, the proportional number of access slots may be maintained unchanged. For example, it may be determined by the node that the reception of data has been successful for received data that has a checksum failure. The data may be determined to be received successfully, when the data is received from a node that is known to the receiving node. A node may be known, when data has been received earlier from the node. When data is received earlier from the node, the node may be determined to be a known node, when checksum of the earlier data has been correct. Accordingly, the checksum of the earlier data reception may be used as a further criterion to determine whether a node originating the data is known. Header information of the received data transmission may be inspected by the receiving node to derive an identifier of the originating node. The identifier may be compared with information, e.g. identifiers and checksum, of the earlier receptions of data to determine, whether the originating node is known.

If 125 the generated predictions indicate that the next active access slot is not for reception of data the method may proceed to synchronizing 107 the node to the communications channel. Once the synchronization is finished, either successfully or unsuccessfully, the method may proceed to switch the communications unit to a low power mode 115 communications unit.

The synchronizing 107 may comprise that the node listen to the communications channel for transmissions for synchronizing to the communications channel. The transmissions may be beacons. The transmissions may include information for synchronizing the node to the communications channel. Synchronizing the node to the communications channel may comprise determining a system frame length, for example. The system frame length may determine beacon transmission time and time instants of access slots may be determined with respect to the system frame.

The transmission of data, reception of data and the synchronization performed in the predicted access slots may generate feedback. The feedback may be used for adapting at least one of the generated predictions for the next active access slot. The adapting may provide that the communications unit that is switched to a low power mode 115 after the transmission of data, reception of data or the synchronization may be switched ON for the next active access slot on the basis of the adapted predictions. The feedback may comprise information indicating success or failure of the operation. Accordingly, the feedback may indicate that a timeout has taken place, a successful reception of data, an unsuccessful reception of data, a successful transmission of data or an unsuccessful transmission of data.

It should be appreciated that, when the communications unit is switched to a low power mode 115 the communications unit may be switched back to the same low power mode, where the communications unit was in the start 101. On the other hand the communications unit may be switched to another low power mode.

An embodiment comprises updating 131, 133, 111, 113 the proportional number of access slots. The updating provides that the proportional number of access slots may be adapted according to the need for access slots. The need for access slots may depend on the number of nodes in the network. For example, if 129 data is not received or if 109 synchronization to the communications channel is unsuccessful it may be determined that the number of nodes in the network has been decreased, whereby also the proportional number of access slots may be decreased 133, 113. On the other hand, if 129 data is received or if 109 the synchronization is successful, it may be determined that the number of nodes in the network has been increased, whereby also the proportional number of access slots may be increased 131, 111. It should be appreciated that the number of nodes in the network for determining the need for access slots may be the number of nodes in the whole network or for a part of the network. A part of the network, e.g. an island or a section, may comprise nodes that are within a communications range from the node.

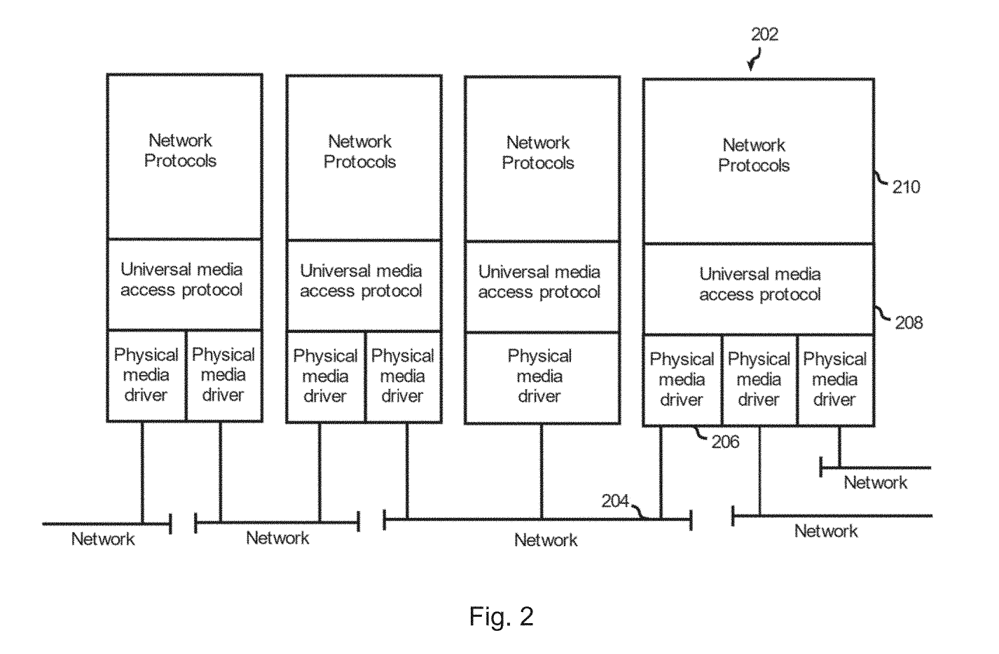

FIG. 2 illustrates a communications network in accordance with at least some embodiments of the present invention. The communications network may be a mesh network. The communications network comprises nodes 202 that are capable of communications in one or more communications networks 204. Each of the networks may have respective communications channels for communications between the nodes of the network. A communications channel may comprise access slots that define transmission opportunities at a defined time instants on the communications channels.

The nodes 202 may comprise physical media drivers 206 corresponding to each communications channel, where the node is capable of communications. The physical media drivers may serve for communication interfaces or communications units in the nodes 202. The physical media drivers may be controlled by a universal media access protocol 208 that is common between the communications channels. In this way the node is capable of communications of data on more than one communications channel according to predictions of active access slots on each of the communications channels. Accordingly, the universal media access protocol may control the physical media drivers such that data may be communicated on active access slots of the communications channels according to predictions of active access slots on each of the communications channels. In this way data communications, such as data transmission and/or data reception, via the communications may be provided channels in a scalable way, whereby power consumption of the network nodes may be kept low.

The data communications on each of the communications channels may follow an access slot pattern that may be determined and maintained separately for each communications channel. In this way data, the node is capable of communications of data, for example a block of data, on more than one communications channel according to predictions of active access slots on each of the communications channels.

Network layer operations of the communications channel may be provided by network layer protocols 210 over the universal media access protocol. Accordingly, the communications channels may be different. For example, the communications channels may be wired or wireless communications channels. Moreover, the wired or wireless communications channels may support different connection technologies. Examples of the connection technologies comprise IEEE 802.11 WLANs, Bluetooth, Ethernet and data buses. Additionally or alternatively, the communications channels may simplex, half duplex, and/or full duplex communications. Additionally or alternatively the communications channels may support point-to-point, point-to-multipoint, multipoint-to-multipoint, multipoint-to-point connections between the nodes.

An electronic device comprising electronic circuitries may be an apparatus for realizing at least some embodiments of the present invention and capable of carrying out at least some of the features illustrated above. The apparatus may be or may be comprised in a computer, a laptop, a tablet computer, a cellular phone, a machine to machine (M2M) device (e.g. a sensor device), a wearable device, or any other apparatus provided with radio communication capability. In another embodiment, the apparatus carrying out the above-described functionalities is comprised in such a device, e.g. the apparatus may comprise a circuitry, such as a chip, a chipset, a microcontroller, or a combination of such circuitries in any one of the above-described devices.

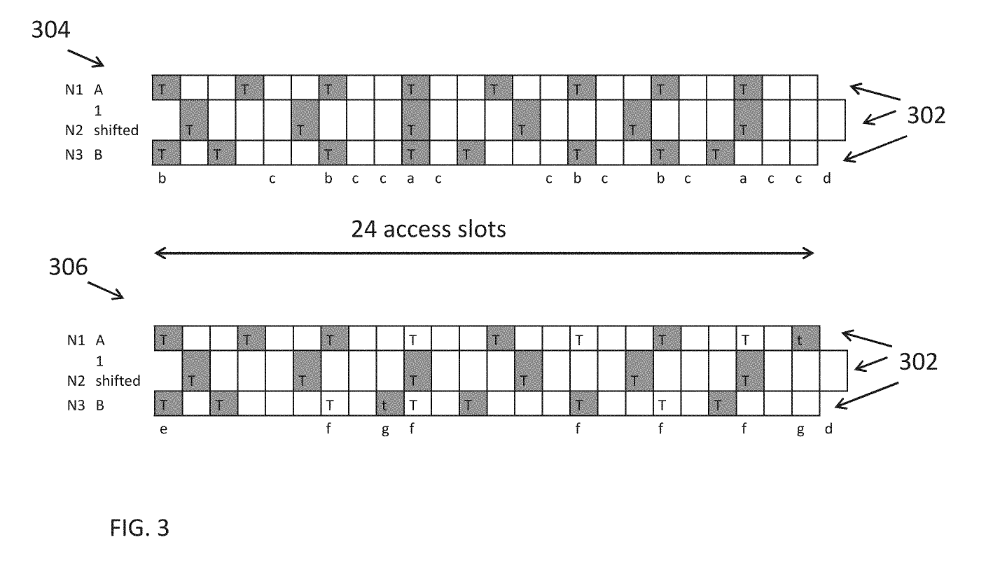

FIG. 3 illustrates an example of utilizing predictions for determining active access slots in accordance with at least some embodiments of the present invention. The active access slots may be access slots on a communications channel of the communications network. Each node may apply an access slot pattern in a system frame. Different nodes may use the same or different access slots patterns 302. An access slot pattern may be defined by a number of active transmit access slots ‘T’ utilized, for transmitting during the active slot, a by a node within a system frame and access slots that the node has utilized for receiving or synchronization ‘ ’ within the system frame. In a given access slot pattern, active transmit access slots ‘T’ may be spaced with equal intervals or unequal intervals. Each utilized active transmit access slot in a pattern may be followed by unutilized active slots, or one, two, three or more further active slots. In the example illustrated in FIG. 3, the system frame length is 24 access slots.

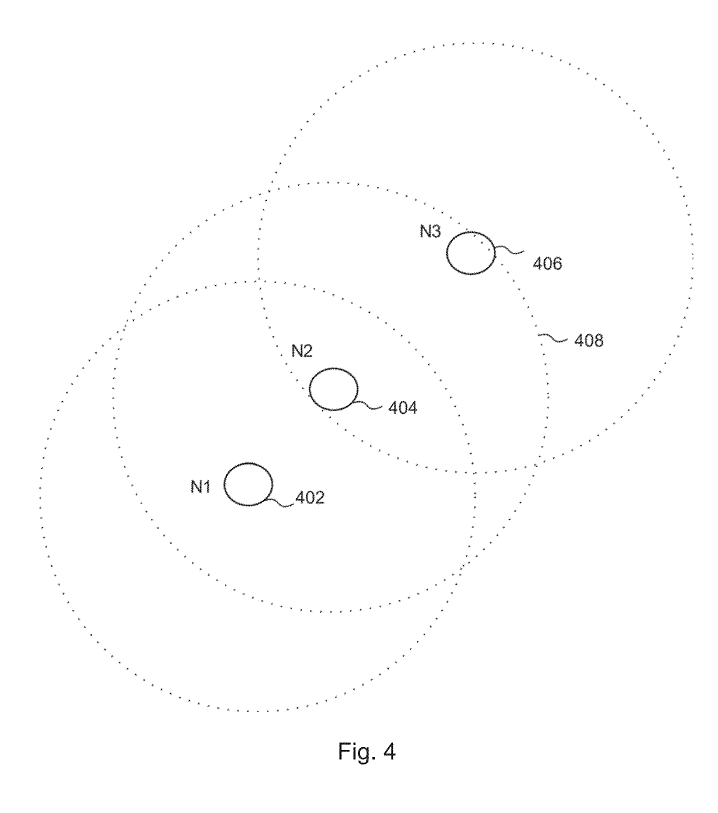

FIG. 4 illustrates an example of a communications scenario in accordance with at least some embodiments of the present invention. The communications scenario may comprise nodes (N1, N2, N3) 402, 404, 406 that are capable of communications on a communications channel of the communications network. The nodes may be in accordance with the nodes described with FIG. 2 and capable of executing the steps of the method of FIG. 1. Each of the nodes may have a range 408 of communications, where transmissions from the node may be received, or “heard”, by another node that is within the range. The transmissions may be wireless transmissions, for example Radio Frequency transmissions. In the example, N2 may hear N1 and N3, but N1 and N3 can hear only N2. Therefore, N1 and N3 do not hear each other.

Next utilizing predictions for determining active access slots are explained referring to both FIG. 3 and FIG. 4. Access slot patterns of N1, N2 and N3 are illustrated in two scenarios 304, 306, where each node N1, N2, N3 has an access slot pattern 302 within a system frame. In a first scenario 304 N1, N2 and N3 have access slot patterns, where predictions are not utilized for determining next active access slots. In a second scenario, predictions of next active access slots are generated and applied by N1, N2 and N3 in transmission of data, reception of data and synchronization on the active access slots.

In the example, the nodes are synchronized to the communications channel, whereby the active access slots in the access slots patterns are timed to take place substantially simultaneously. The white active access slots in the access slots patterns are utilized for listening and the grey access slots including ‘T’ are utilized for transmitting. Low power modes are not illustrated, but a node may enter a low power mode for example as described in step 115 in FIG. 1. Thanks to the synchronization of the nodes, the active access slots of the nodes are aligned, whereby once a communications unit of the node is switched ON after the low power mode, the access slot may be utilized by the node for transmitting, receiving or synchronizing.

The system frames may be shifted in time or by one or more access slots with respect to each other as can be seen from the system frame shifted for N2 in both scenarios. On the other hand start and end times of the system frames may be synchronized as can be seen from the system frames of N1 and N3. Ratio of active access slots to active transmit access slots may be adjusted in each access slot pattern. In the example, N1 and N3 have active access slots to active transmit access slots ratio 3 and N2 has active access slots to active transmit access slots ratio 4.

In the first scenario item ‘a’ identifies access slots, where transmissions of the nodes interfere with each other, since the nodes are within each other range 408. Item ‘b’ identifies a potential hidden node issue: N2 hears N1 or N3 or cannot receive correctly at all. The hidden node issue of item ‘b’ may be solved by including prediction rules to take account that issue with feedback from N2 node. Item ‘c’ identifies ‘empty’ active slots in system, when none of the nodes is transmitting, but each node is either receiving or synchronizing. Prediction may provide that the empty active slots identified in item ‘c’ may be utilized for transmitting to increase system transmission efficiency. However the empty slots may exist even if prediction is utilized to allow new nodes or mobile nodes start their transmit activity optimally on the empty access slots. Item ‘d’ identifies start of next system frame. Prediction may be used to predict which access slot pattern the other nodes take into use and to determine what a good pattern to be utilized by the node.

In the second scenario, item ‘e’ identifies access slots, where prediction has not been used to optimize utilization of the access slots because not enough information available. In an example, prediction may not be possible to use if not enough data is transferred correctly. Item ‘f’ identifies access slots, where use of predictions has provided that some nodes have not utilized their active transmit access slots to transmitting but receiving or synchronizing, whereby system performance may be supported, since transmissions could have degraded system performance. Item ‘g’ identifies access slots, where use of predictions has provided that some of the nodes have utilized active access slots utilized for listening in the first scenario for transmitting in the second scenario, such that system performance may be supported. Accordingly, when the predictions are not utilized the access slot patterns of the first scenario had issues identified by items ‘b’ and ‘c’. However, after the predictions are used to determine the active access slots, the potential hidden node problems have been solved since the access slots having the potential hidden node problem are predicted and active access slots are not utilized for transmitting but receiving or synchronization T. Moreover, the empty active access slots ‘c’ may be predicted and utilized for transmissions ‘g’.

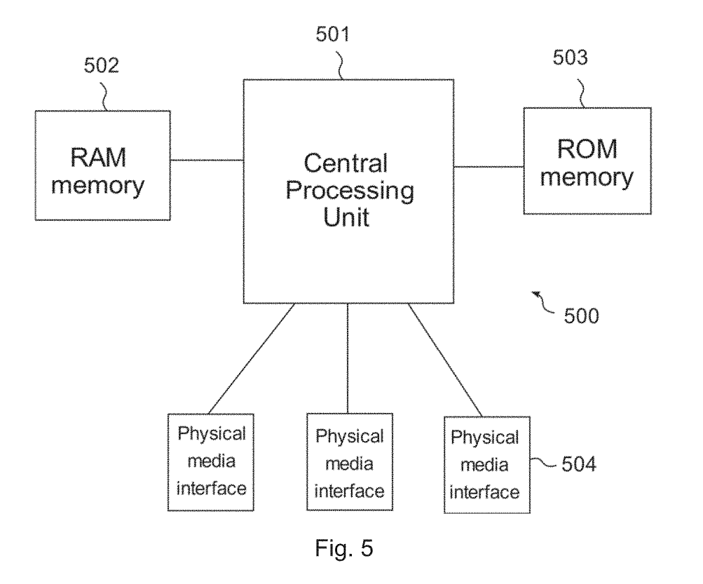

FIG. 5 illustrates an apparatus 500 in accordance with at least some embodiments of the present invention. The apparatus may be a node in a communications network, in some embodiments a mesh network, and caused to perform one or more functionalities according an embodiment. A node may be attached to the network, and capable of creating packets to be transmitted over a communications channel, receiving, or transmitting packets on a communications channel. The apparatus may be arranged to carry out at least some of the embodiments related to slotted channel access. The apparatus may include one or more controllers configured to carry out operations in accordance with at least some of the embodiments illustrated above, such as some or more of the features illustrated in connection with FIG. 1.

The apparatus 500 may comprise a processor 501 and a memory 502, 503, and one or more communication interfaces 504. The processor may comprise one or more processing cores. The processor may comprise at least one application-specific integrated circuit, ASIC. The processor may comprise at least one field-programmable gate array, FPGA. The processor may be means for performing method steps in the apparatus.

The memory may comprise random-access memory and/or permanent memory. The memory may comprise at least one RAM chip. The memory may comprise solid-state, magnetic, optical and/or holographic memory, for example. The memory may be at least in part accessible to the processor 501. The memory may be at least in part comprised in the processor 501. The memory may store a computer program comprising computer instructions that the processor is configured to execute, to cause one or more functionalities described in the embodiments. The processor and the memory may be operatively connected to the processor for communications of data for execution of the computer program by the processor. The connection between the processor and the memory may be a data bus for example. When computer instructions configured to cause the processor to perform certain actions are stored in the memory, and the apparatus in overall is configured to run under the direction of the processor using computer instructions from the memory, the processor and/or its at least one processing core may be considered to be configured to perform said certain actions. The memory may be at least in part comprised in the processor. The memory may be at least in part external to the apparatus 500 but accessible to the apparatus. Control parameters affecting operations in the apparatus may be stored in one or more portions of the memory and used to control operation of the apparatus.

The communications interfaces may provide a communications channel for communications of packets in the network. Examples of the communications interfaces comprise network interface cards and network interface modules that may be connected to the apparatus by means of wired or wireless connections. Wireless connections may comprise Bluetooth and IEEE 802.11 based Wireless Local Area Network (WLAN) connections, for example. The wired connections may comprise data buses and Ethernet, for example. The processor 501 may be operated to control at least some of the communications interfaces 504 by applying at least some of embodiments associated with slotted channel access and illustrated above in connection with FIG. 1.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though a member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the foregoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, i.e. a singular form, throughout this document does not exclude a plurality.

1. A method for slotted channel access in a communications network, comprising:
determining, by a node of a communications network, a current proportional number of access slots for communications in the communications network;
generating, by the node, predictions of a next active access slot on a communications channel on the basis of the current proportional number of access slots;
switching ON, from a low power mode, a communications unit of the node on the basis of at least one generated prediction for the next active access slot for an operation comprising at least one of a transmission of data, reception of data and synchronization;
switching the communications unit of the node back to the same low power mode or to another low power mode after the operation has been performed; and
adapting at least one of the generated predictions for the next active access slot on the basis of feedback for operations performed in one or more previous active access slots.

2. method according to claim 1, further comprising increasing the proportional number of access slots on the communications channel on successful reception of data or on synchronization to the communications channel.

3. The method according to claim 1, further comprising decreasing the proportional number of access slots on the communications channel if the reception of data or synchronization to the communications channel is unsuccessful.

4. The method according to claim 1, wherein the low power mode comprises that the communications unit is switched off or the communications unit is in a standby mode.

5. The method according to claim 1, wherein when the communications unit is switched ON the node is capable of at least one of:
transmitting and receiving data and
signaling on the communications channel,
in at least one access slot of the communications channel in an operational mode having a regular or increased power consumption.

6. The method according to claim 1, wherein the node is capable of communications of data on more than one communications channel according to predictions of active access slots on each of the communications channels.

7. An apparatus comprising at least one processing core, at least one memory including computer program code, the at least one memory and the computer program code being configured to, with the at least one processing core, cause the apparatus at least to perform a method for slotted channel access in a communications network, the method comprising:
determining, by a node of a communications network, a current proportional number of access slots for communications in the communications network;
generating, by the node, predictions of a next active access slot on a communications channel on the basis of the current proportional number of access slots;
switching ON, from a low power mode, a communications unit of the node on the basis of at least one generated prediction for the next active access slot for an operation comprising at least one of a transmission of data, reception of data and synchronization;
switching the communications unit of the node back to the same low power mode or to another low power mode after the operation has been performed; and
adapting at least one of the generated predictions for the next active access slot on the basis of feedback for operations performed in one or more previous active access slots.

8. The apparatus according to claim 7, further comprising more than one communications interfaces controlled by a universal media access protocol and the apparatus is caused to communicate data on active access slots of the communications channels according to predictions of active access slots on the communications channels.

9. (canceled)

10. A non-transitory computer readable medium having stored thereon a set of computer readable instructions that, when executed by at least one processor, cause a node of a communications network to carry out a method for slotted channel access in a communications network, the method comprising:
determining, by a node of a communications network, a current proportional number of access slots for communications in the communications network;
generating, by the node, predictions of a next active access slot on a communications channel on the basis of the current proportional number of access slots;
switching ON, from a low power mode, a communications unit of the node on the basis of at least one generated prediction for the next active access slot for an operation comprising at least one of a transmission of data, reception of data and synchronization;
switching the communications unit of the node back to the same low power mode or to another low power mode after the operation has been performed; and
adapting at least one of the generated predictions for the next active access slot on the basis of feedback for operations performed in one or more previous active access slots.

11. The apparatus according to claim 7, wherein the apparatus is caused to increase the proportional number of access slots on the communications channel on successful reception of data or on synchronization to the communications channel.

12. The apparatus according to claim 7, wherein the apparatus is caused to decrease the proportional number of access slots on the communications channel if the reception of data or synchronization to the communications channel is unsuccessful.

13. The apparatus according to claim 7, wherein the low power mode comprises that the communications unit is switched off or the communications unit is in a standby mode.

14. The apparatus according to claim 7, wherein when the communications unit is switched ON the node is capable of
transmitting and receiving data and
signaling on the communications channel,
in at least one access slot of the communications channel in an operational mode having a regular or increased power consumption.

15. The apparatus according to claim 7, wherein the node is capable of communications of data on more than one communications channel according to predictions of active access slots on each of the communications channels.
